(19) United States
(12) Patent Application Publication
(10) Pub. No.: US 2006/0198539 A1
(43) Pub. Date: Sep. 7, 2006

(54) Signal transmission mechanism between wireless microphone and receiver

(76) Inventor: David Kung, Chia-Yi City (TW)

Correspondence Address: David Kung, P.O. Box 90, Tainan City, 70499, TW

(21) Appl. No.: 11/062,818

(22) Filed: Feb. 23, 2005

(51) Int. Cl. H04R 3/00; H04B 1/16

(52) U.S. Cl. 381/113; 455/334; 381/111

(57) ABSTRACT

A signal transmission mechanism between a wireless microphone and a receiver comprises a receiver, a wireless microphone and a microphone transmitter. A recess is formed on a surface of the receiver, wherein a plurality of electric contact points is disposed within the recess for facilitating an electric contact with either the wireless microphone or the microphone transmitter. The wireless microphone and the microphone transmitter respectively have extended rear ends capable of being coupled with the recess of the receiver and respectively have electric contact points, whereby the electric contact points of the wireless microphone or the microphone transmitter will be in electric contact with a corresponding set of the electric contact points of the receiver for frequency alignment. Since the frequency alignment is achieved through direct contact, the process of alignment will be quick, precise and free from external radio disturbances.

### FIELD OF THE INVENTION

The present invention relates to signal transmission mechanisms between a wireless microphone and a receiver, more particularly to a signal transmission mechanism between a wireless microphone and a receiver wherein a recess is formed on a surface of the receiver and a plurality of electric contact points is disposed within the recess for facilitating an electric contact with either a wireless microphone or a microphone transmitter of a mini-microphone. The wireless microphone and the microphone transmitter respectively have extended rear ends capable of being coupled with the recess of the receiver and respectively have electric contact points, whereby the electric contact points of the wireless microphone or the microphone transmitter will be in electric contact with a corresponding set of the electric contact points of the receiver for frequency alignment. Since the frequency alignment is achieved through direct contact, the process of alignment will be quick, precise and free from external radio disturbances.

### BACKGROUND OF THE INVENTION

A microphone and an associated receiver are commonly used in public occasions such as a lecture, a concert and instruction to a large group of people. Conventional microphones are categorized into the wired and the wireless. A wired microphone is connected to a receiver by a wire. The signals are transmitted to the receiver through the wire and then amplified and sent to the speakers. A process of frequency alignment is not necessary. However, the usage of wired microphones is subject to limitation of the length of the wire and entangling of the wires, which are inconvenient. On the other hand, the usage of a wireless microphone is not concerned with the problems of wires. Nevertheless, a process of frequency alignment is necessary. To align the signal frequency of the microphone with the receiver frequency, the microphone is brought to the proximity of the receiver, and a button of frequency alignment for a period time to accomplish the alignment. However, the alignment could be disturbed by the radio signals pre-existing in the surroundings, resulting in a mismatch of frequencies that could mar the audio effect of the broadcasting.

### SUMMARY OF THE INVENTION

Accordingly, the objective of the present invention is to provide a signal transmission mechanism between a wireless microphone and a receiver that is quick, precise and free from external radio disturbances.

To achieve the objective, the signal transmission mechanism comprises a receiver having a frequency-alignment circuit and a recess formed on a surface thereof; and a wireless microphone having an extended rear end capable of being coupled with the recess of the receiver. A plurality of electric contact points are disposed within the recess of the receiver, and a plurality of electric contact points are disposed at the rear end of the wireless microphone, whereby an electric contact can be achieved as the wireless microphone is mounted on the receiver for frequency alignment.

To use with a mini-microphone, the signal transmission mechanism comprises a receiver having a frequency-alignment circuit and a recess formed on a surface thereof; and a microphone transmitter having an extended rear end capable of being coupled with the recess of the receiver. A plurality of electric contact points are disposed within the recess of the receiver, and a plurality of electric contact points are disposed at the rear end of the microphone transmitter, whereby an electric contact can be achieved as the microphone transmitter is mounted on the receiver for frequency alignment.

### BRIEF DESCRIPTION OF DRAWINGS

FIG. 1 is a perspective view of a signal transmission mechanism between a wireless microphone and a receiver according to the present invention.

FIG. 2 illustrates the coupling between the wireless microphone and the receiver of the signal transmission mechanism of the present invention.

FIG. 3 illustrates the coupling between the microphone transmitter and the receiver of the signal transmission mechanism of the present invention.

FIG. 4 is a perspective view of another preferred embodiment of the present invention wherein the wireless microphone or the microphone transmitter is connected to the receiver on a lateral wall thereof.

FIG. 5 illustrates the coupling between the wireless microphone and the receiver of the preferred embodiment in FIG. 4.

FIG. 6 illustrates the coupling between the microphone transmitter and the receiver of the preferred embodiment in FIG. 4.

### DETAILED DESCRIPTION OF THE PREFERRED EMBODIMENTS

The various objects and advantages of the present invention will be more readily understood from the following detailed description when read in conjunction with the appended drawings.

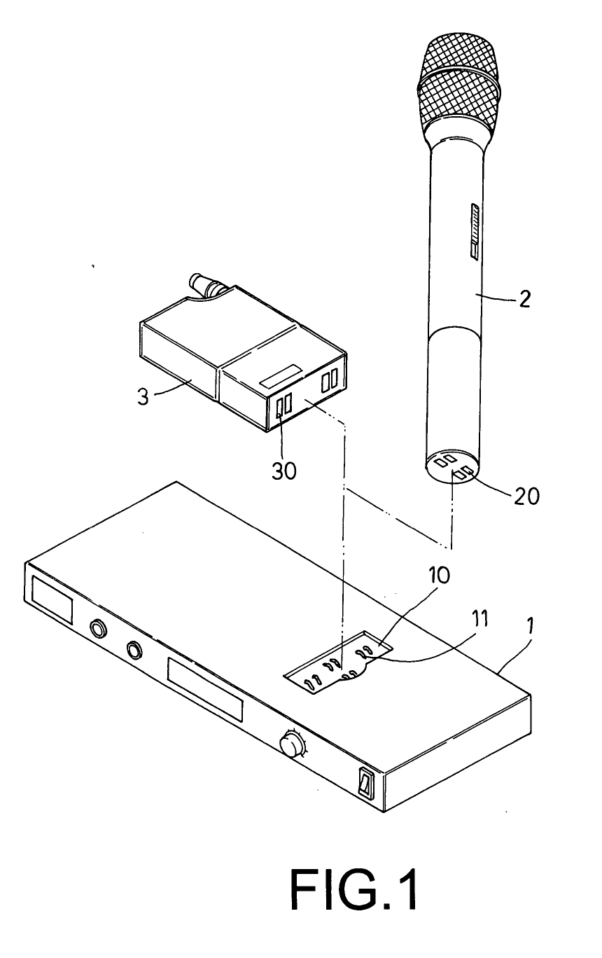

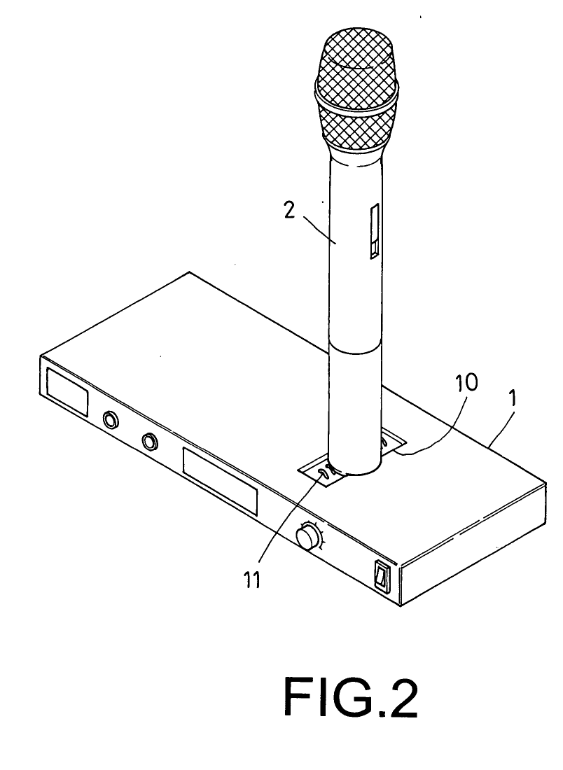

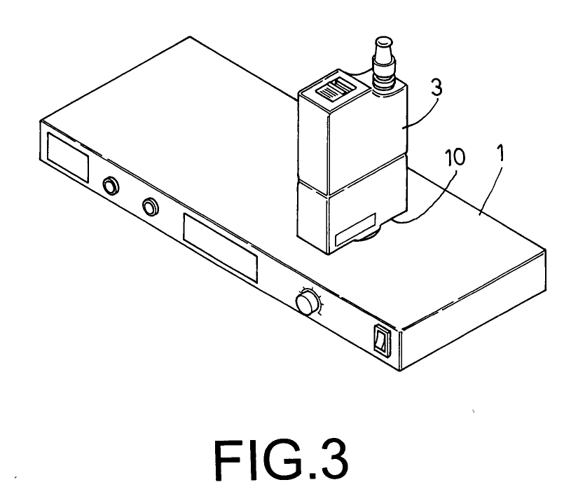

Referring to FIGS. 1, 2 and 3, a signal transmission mechanism between a wireless microphone and a receiver according to the present invention comprises a receiver 1 provided with a frequency-alignment circuit, a wireless microphone 2 and a microphone transmitter 3. A top surface of the receiver 1 is further provided with a recess 10 for receiving the rear end of the wireless microphone 2, whereby a plurality of electric contact points 20 located on the rear end of the wireless microphone 2 can be engaged with a corresponding set of the electric contact points 10 located within the recess 10. Further, the rear end of the microphone transmitter 3 is provided with a plurality of electric contact points 30, which will be engaged with a corresponding set of the electric contact points 10 of the recess 10 as the receiver 1 and the microphone transmitter 3 are coupled.

Referring to FIGS. 1, 2 and 3, the usage of the signal transmission mechanism comprises steps of: (1) inserting the rear end of the wireless microphone 2 into the recess 10 on the receiver 1 for frequency synchronization; (2) removing the wireless microphone 2 from the receiver 1 and using it alone. In the first step, the insertion of the wireless microphone 2 into the receiver 1 brings the electric contact points 20 and a corresponding set of the electric contact points 11 into an electric contact, whereby the wireless microphone 2 is electrically connected to the frequency-alignment circuit of the receiver 1. A frequency signal is then transmitted from the receiver 1 to the wireless microphone 2 to align the transmission frequency of the wireless microphone 2 with the frequency signal from the receiver 1. When a mini-microphone (not sown in the figures) is used, the microphone transmitter 3 of the mini-microphone will be inserted into the top surface of the receiver 1, whereby the electric contact points 30 at the rear end will be brought into contact with a corresponding set of the electric contact points 11 and whereby the microphone transmitter 3 and the receiver 1 are electrically connected for frequency synchronization. A frequency signal is then transmitted from the receiver 1 to the microphone transmitter 3 to align the transmission frequency of the mini-microphone with the frequency signal from the receiver 1. Removing the microphone transmitter 3 from the receiver 1, the mini-microphone will be then used alone. The process of synchronization through the electric contact points 11, the electric contact points 20 and the electric contact points 30 is quick and precise, therefore facilitating a signal transmission means without external disturbances.

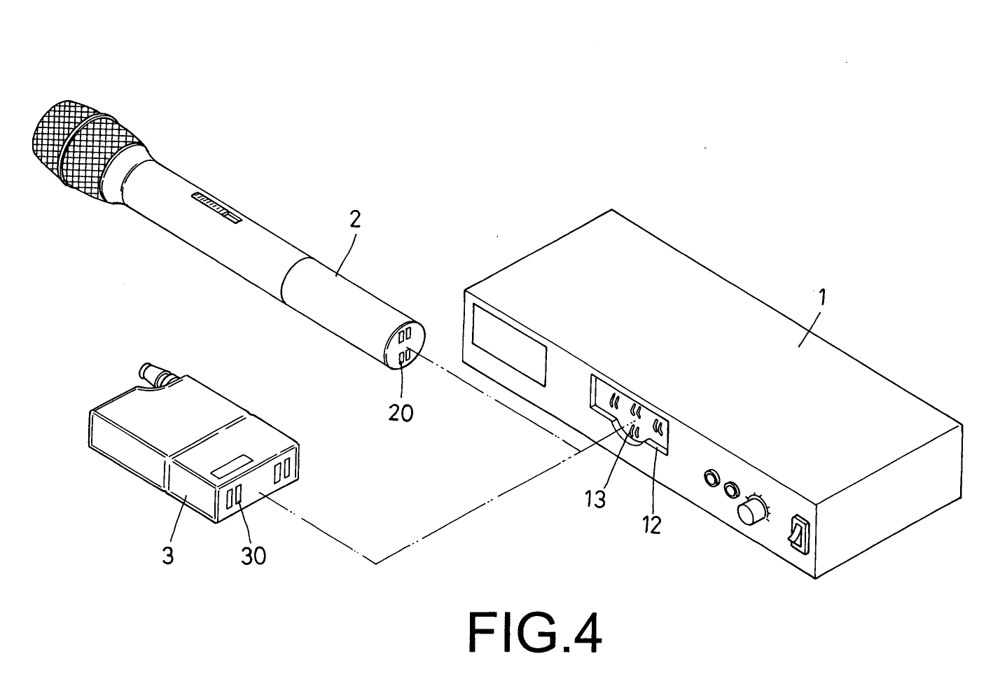

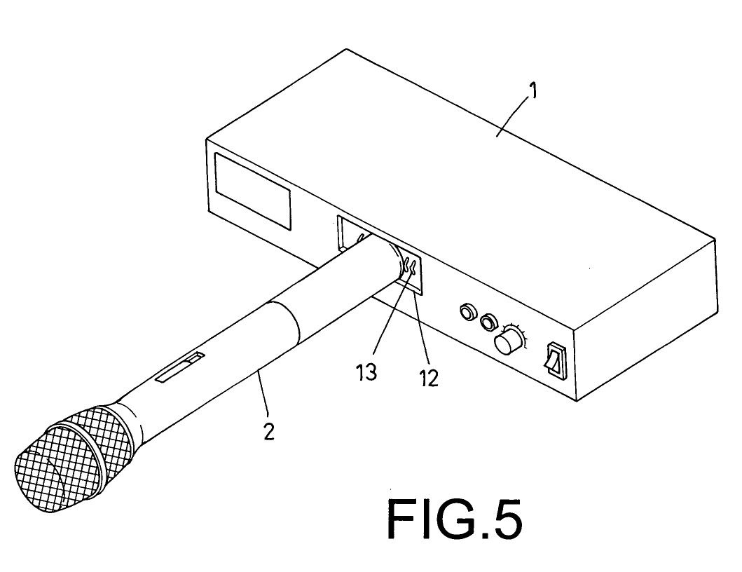

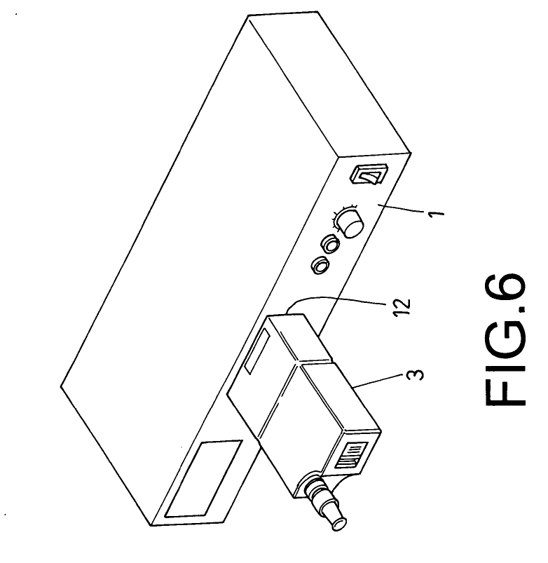

Refer to FIGS. 4, 5 and 6 for another preferred embodiment of the present invention, wherein the receiver 1 has a recess 12 provided on a lateral face of the recess 12 for receiving the rear ends of the wireless microphone 2 and the microphone transmitter 3. The recess 12 further includes a plurality of electric contacts 13 for engaging the electric contact points 20 of the wireless microphone 2 and the electric contact points 30 of the microphone transmitter 3. The usage and function of this preferred embodiment are the same as those of the first preferred embodiment.

The present invention is thus described, and it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A signal transmission mechanism between a wireless microphone and a receiver comprising:
a receiver having a frequency-alignment circuit and a recess formed on a surface thereof, a plurality of electric contact points being disposed within said recess for facilitating an electric contact with an external device; and
a wireless microphone having an extended rear end capable of being coupled with said recess of said receiver, said rear end of said wireless microphone being provided with a plurality of electric contact points, whereby by said wireless microphone will be mounted on said receiver, and whereby said electric contact points of said wireless microphone will be in electric contact with a corresponding set of said electric contact points of said receiver for frequency alignment.

2. A signal transmission mechanism between a wireless microphone and a receiver comprising:
a receiver having a frequency-alignment circuit and a recess formed on a surface thereof, a plurality of electric contact points being disposed within said recess for facilitating an electric contact with an external device; and
a microphone transmitter having an extended rear end capable of being coupled with said recess of said receiver, said rear end of said microphone transmitter being provided with a plurality of electric contact points, whereby by said microphone transmitter will be mounted on said receiver, and whereby said electric contact points of said microphone transmitter will be in electric contact with a corresponding set of said electric contact points of said receiver for frequency alignment.
